(19) United States
(12) Patent Application Publication
(10) Pub. No.: US 2007/0209498 A1
(43) Pub. Date: Sep. 13, 2007

(54) Midi Encoding and Decoding

(76) Inventors: Ulf Lindgren, Vastra Frolunda (SE); Harald Gustafsson, Lund (SE)

Correspondence Address: ERICSSON INC., 6300 LEGACY DRIVE, M/S EVR 1-C-11, PLANO, TX, 75024, US

(21) Appl. No.: 10/596,572

(22) PCT Filed: Dec. 17, 2004
(86) PCT No.: PCT/EP04/14567

§ 371 Date: Feb. 21, 2007

Related U.S. Application Data
(60) Provisional application No. 60/533,830, filed on Dec. 29, 2003.

(30) Foreign Application Priority Data
Dec. 18, 2003 (EP) 03388088.1

(51) Int. Cl. G10H 7/00

(52) U.S. Cl. 84/609

(57) ABSTRACT

A method and unit for composing or decomposing a multimedia signal according to the Musical Instrument Digital Interface (MIDI) protocol. The signal carries events of a first type, which are arranged to carry instructions regarding which predefined patches to use for playback and which predefined notes to play, and events of a second type which carry additional content. The signal is parsed to identify events of the second type and to read the additional content. Coded samples of multimedia content are loaded at an address specified in the additional content. The coded samples are then decoded to provide the samples for playback of the multimedia content. In this manner, vocal song or vocals and other audio type signals are efficiently conveyed utilizing the widely used MIDI protocol.

This invention relates to a method of rendering a multimedia signal, in particular a multimedia signal according to the Musical Instrument Digital Interface (MIDI) specification. According to the MIDI specification, the multimedia signal carries a description of a musical composition by means of events of a first type that are arranged to carry instructions to a unit which of patches to use for playback, which of notes to play, and at which of sound levels to play each of the notes. Optionally, the MIDI specification allows use of events of a second type, which are arranged to carry additional content.

Additionally, the invention relates to a unit of rendering a multimedia signal.

The Musical Instrument Digital Interface (MIDI) protocol provides a standardized and efficient means of conveying musical performance information as electronic data. MIDI information is transmitted in ‘MIDI messages’, which can be thought of as instructions that tell a music synthesizer how to play a piece of music. The synthesizer receiving the MIDI data must generate the actual sounds. The sounds are generated from predefined, sounds e.g. sampled and stored in wave tables. A wave table defines musical instruments and contains audio samples of the musical instruments. In connection herewith, an instrument map is a collection of instrument names, where each instrument name is associated with a number, 0-127, also known as a program number. Thus, the instrument map itself does not contain information about how an instrument sounds. Additionally, the instrument map can specify less than 128 instruments. Moreover, a so-called patch is an alternative name for a program and means a specific instrument (referred to via a number, 0-127) or a specific drum-kit. The general MIDI specification defines a standard set of instruments comprising 128 instruments e.g. a piano, a flute, a trumpet, different drums etc. The MIDI Detailed Specification published by the MIDI Manufacturers Association, Los Angeles, Calif., provides a complete description of the MIDI protocol.

The MIDI protocol was originally developed to allow musicians to connect synthesizers together, the MIDI protocol is now finding widespread use as a delivery medium to replace or supplement digitized audio in games and multimedia applications. There are several advantages to generating sound with a MIDI synthesizer rather than using sampled audio from disk or CD-ROM. The first advantage is storage space. Data files used to store digitally sampled audio in Pulse Code Modulation (PCM) format (such as .WAV files) tend to be quite large. This is especially true for lengthy musical pieces captured in stereo using high sample rates.

MIDI data files, on the other hand, are extremely small when compared with sampled audio files. For instance, files containing high quality stereo sampled audio require about 10 Mbytes of data per minute of sound, whereas a typical MIDI sequence might consume less than 10 Kbytes of data per minute of sound. This is because the MIDI file does not contain the sampled audio data; it contains only the instructions needed by a synthesizer to play the sounds. These instructions are in the form of MIDI messages that instruct the synthesizer e.g. which patches to use, which notes to play, and how loud to play each note. The actual sounds are generated by the synthesizer. Other advantages of using MIDI to generate sounds include the ability to easily edit the music, and the ability to change the playback speed and the pitch or key of the sounds independently.

The recipient of this MIDI data stream is commonly a MIDI sound generator or sound module, which will receive MIDI messages at its MIDI IN connector, and respond to these messages by playing sounds.

MIDI files contain one or more MIDI streams, with time information for each event. The event can be a regular MIDI command or an optional META event which can carry information of lyrics, and tempo. ‘Lyrics’ and ‘Tempo’ are examples of such META events. Lyric, sequence, and track structures, tempo and time signature information are all well supported. In addition, track names and other descriptive information may be stored with the MIDI data as META events.

MIDI files are made up of chunks. A MIDI file always starts with a header chunk followed by one or more track chunks. Basically, a chunk comprises a value indicating the size of the chunk and a series of messages.

This structure of the MIDI protocol allows for a very efficient representation of the instrumental portion of a musical composition due to the utilization of predefined sounds for notes of instruments used in the composition.

However, often vocal song or vocals is an appreciable portion of a musical composition. The MIDI protocol happens to be insufficient for handling a vocal song or vocals or a vocal song or vocals portion of a musical composition. An explanation to this insufficiency is that vocal song or vocals can not be represented by playing of tones from a relevant MIDI map.

From a memory consumption point of view, a musical composition can be sampled, typically by use of Pulse Coded Modulation, compressed by coding for efficient storage, and decoded for the purpose of reproduction or playback. Typical encoding/decoding schemes comprise MP3, which is the MPEG layer 3 (MPEG=Moving Picture Experts Group); AMR (Adaptive Multi Rate); and AAC (Advanced Audio Codec). However, whether in compressed or uncompressed form, a sampled musical composition will not provide access to the protocol according to which the composition is stored for manipulation of individual notes of the musical composition and how they are played since this information is lost during sampling.

Thus, there exists no efficient way for the combined storage of the vocal song or vocals portions and instrumental portions of a musical composition.

The above and other problems are solved by a method of rendering a multimedia signal, the multimedia signal comprising:

events of a first type arranged to carry content in the form of instructions to a rendering unit; and an event of a second type arranged to carry additional content, wherein said additional content comprises an address identifying an encoded sample of multimedia content; wherein the method comprises the following steps:
generating a multimedia output in response to the events of the first type;
parsing the multimedia signal to identify said event of the second type and to read the additional content;
loading the encoded sample of multimedia content identified by said address;
decoding the encoded sample to provide a decoded sample for playback of the multimedia content; and
superimposing the decoded sample on the generated multimedia output in accordance with timing information associated to the event of the second type.

Consequently, a MIDI representation of a musical composition can also provide efficient means of conveying vocal song or vocals or other audio performance. Since information of vocal song or vocals is conveyed by means of events which typically are dedicated to other purposes than determination of which instrument patches to use, which instrument notes to play, and which sound level to play an instrument note at, the representation of the musical instrument performance will not be corrupted. The additional content of the events conveying the vocal song or vocals performance comprises an address to the encoded samples of the sampled multimedia content, which may comprise the vocal song or vocals performance. Thereby, the encoded samples may be located either inside (cf inline) or outside (external) a signal carrying the MIDI presentation; this signal may be denoted a multimedia signal. For example, the multimedia signal may be a container file comprising a MIDI signal and one or more encoded samples. In some embodiments, the encoded samples are outside the multimedia signal. Thereby, the multimedia signal which is a MIDI signal is not loaded with the load of the encoded samples. Despite being compressed it may be convenient to handle the encoded samples at a location external to the MIDI signal. Apparatuses reading the MIDI signal and which do not support reproduction of the vocal song or vocals performance are thereby not loaded with the coded samples. Hence, since the additional content comprises an address of an encoded sample of sampled multimedia content, the rendering unit can access the encoded sample, decode it and superimpose it on the generated output signal. Furthermore, if a particular multimedia component occurs at more than one location within a MIDI file, the corresponding encoded sample only needs to be provided once, since it can be addressed from different events within the MIDI file. Consequently, a particularly compact multimedia signal can be achieved.

The address may include a file name, a memory address, an offset within a file or memory section, or any other suitable pointer to the location of the encoded sample. The additional content may comprise further information, such as one or more commands of a command set and/or further information or parameters, such as a number of repetitions for the encoded sample, a coding type/scheme of the encoded example, a MIME type, or the like.

It is an advantage of the method described herein that it provides a mechanism for playing a large variety of multimedia content within the framework of standard MIDI files, i.e. without requiring modification to the existing MIDI standard. Consequently, a high degree of compatibility with existing MIDI systems is provided.

In a preferred embodiment, the method additionally comprises the step of inserting samples of the first type. This allows for composing the multimedia signal from sources of MIDI and vocal song or vocals/audio/video that supplies content in simultaneous streams. Alternatively, the multimedia signal can be composed of MIDI and vocal song or vocals/audio/video content stored in Random Access Memory types.

By superimposing the decoded samples on the output signal in accordance with timing information associated to the events of the second type, a multimedia signal may be rendered with correct relative timing of its different components, even if they are not all directly representable by the MIDI format.

Preferably, the method comprises the step of inserting a delta-time value before each of the events of the second type, wherein the delta-time value represents a point in time at which to begin playback of the sampled multimedia content. This use of delta-time values allows for specifying precisely at which delta-time instant a given portion or part of the encoded vocal performance is to be played. Thereby synchronization means is provided to synchronize the musical and the vocal parts of a composition. When the multimedia signal is being composed a delta-time counter can be utilized to obtain a time-stamp for use in inserting a delta-time value before an event of the second type, which carries a reference to the vocal performance. Thereby, the composition of the musical part and the vocal part of the multimedia signal can utilize a common delta-time counter.

Alternatively, the vocal part can be composed with delta-time values made relative to delta-time values in an existing file or stream of event of the first type, which carries the musical part.

As mentioned in the introduction, the invention also relates to a unit/device for rendering a multimedia signal, the multimedia signal comprising:

events of a first type which are arranged to carry content in the form of instructions to the unit; and an event of a second type arranged to carry additional content, wherein said additional content comprises an address identifying an encoded sample of multimedia content; wherein the unit comprises:

a playback unit adapted to generate a multimedia output in response to the events of the first type;

a parser arranged to identify the event of the second type and to read the additional content;

an interface arranged to load the encoded sample of multimedia content identified by said address, and to cause a decoder to decode the decoded sample for subsequent playback of the multimedia content;

a synchronising unit adapted to synchronise playback of the decoded sample with the generation of the multimedia output.

In preferred embodiments, the events of the second type comprise System Exclusives events as defined in the specification of the Musical Instrument Digital Interface (MIDI). System Exclusives events, also referred to as so-called sysex events, are defined to be associated with a manufacture centrally issued and registered identification number. A normal, complete System Exclusive event is stored as four components; a first being an identifier with the hexadecimal value ‘F0’, a second being a hexadecimal value of the number of bytes to be transmitted after ‘F0’, a third being the additional content, and a fourth being a terminator with the hexadecimal value ‘F7’. According to the invention, the additional content comprises the address at which to retrieve the coded audio data.

When the events of the second type comprise Meta-events as defined in the specification of the Musical Instrument Digital Interface (MIDI), additional possibilities of representing a musical composition is provided.

In preferred embodiments the events of the second type comprise Meta-events of the type cue-points, identified by the HEX value FF 07. A cue-point event comprise three components; a first being an identifier with the hexadecimal value ‘FF 07’, a second being a hexadecimal value of the number of bytes to be transmitted after ‘FF 07’, and a third being the additional content.

Preferably, the events of the second type comprise Meta-events of the type lyric, identified by the hexadecimal value FF 05.

Preferably, the events of the second type comprise Meta-events of the type text, identified by the hexadecimal value FF 01.

When an address indicates a position in a first file associated with the multimedia signal an increased flexibility of distributing the multimedia signal is obtained in that the file can contain multiple chunks of coded samples that can be addressed individually. Additionally, a specific chunk of coded samples can be addressed more than one time in a signal. This can result is reuse of the coded samples and thus further compression of the multimedia content. The address can indicate byte counts or positions in the file or frames or chunks numbers in the file. Additionally or alternatively, the address can comprise a Unified Resource Locator (URL) which can point to local or remotely stored files.

According to a preferred embodiment, the multimedia signal is stored in a second file. This second file can be a standard MIDI file. Preferably, the first file and the second file are embedded in a common file container which allows for efficient transfer of the files.

The additional content may comprise an indication of the type of the coding scheme used for encoding the encoded samples. Thereby, it is possible to select one of multiple encoding/decoding schemes e.g. as a consequence of new and improved schemes being developed or in order to be able to select one scheme determined to be the most efficient schemes among other schemes.

The invention will be explained in more detail with reference to the drawing in which:

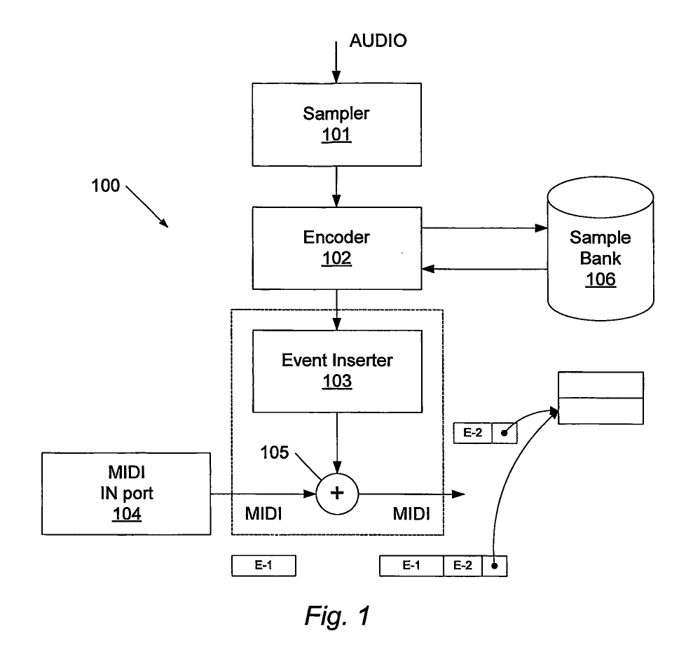

FIG. 1 illustrates a unit for composing a multimedia signal;

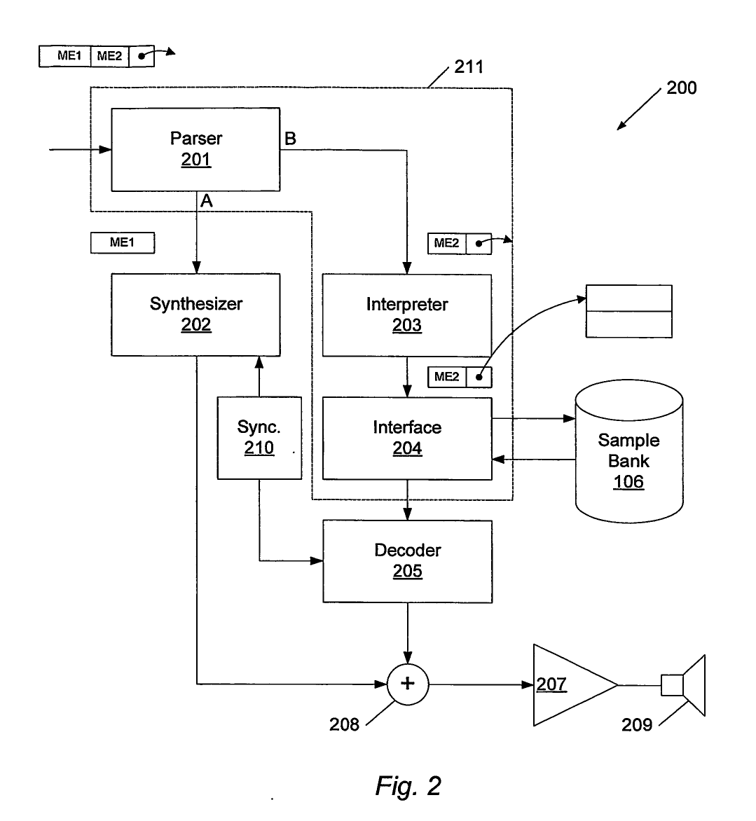

FIG. 2 illustrates a unit for decomposing a multimedia signal;

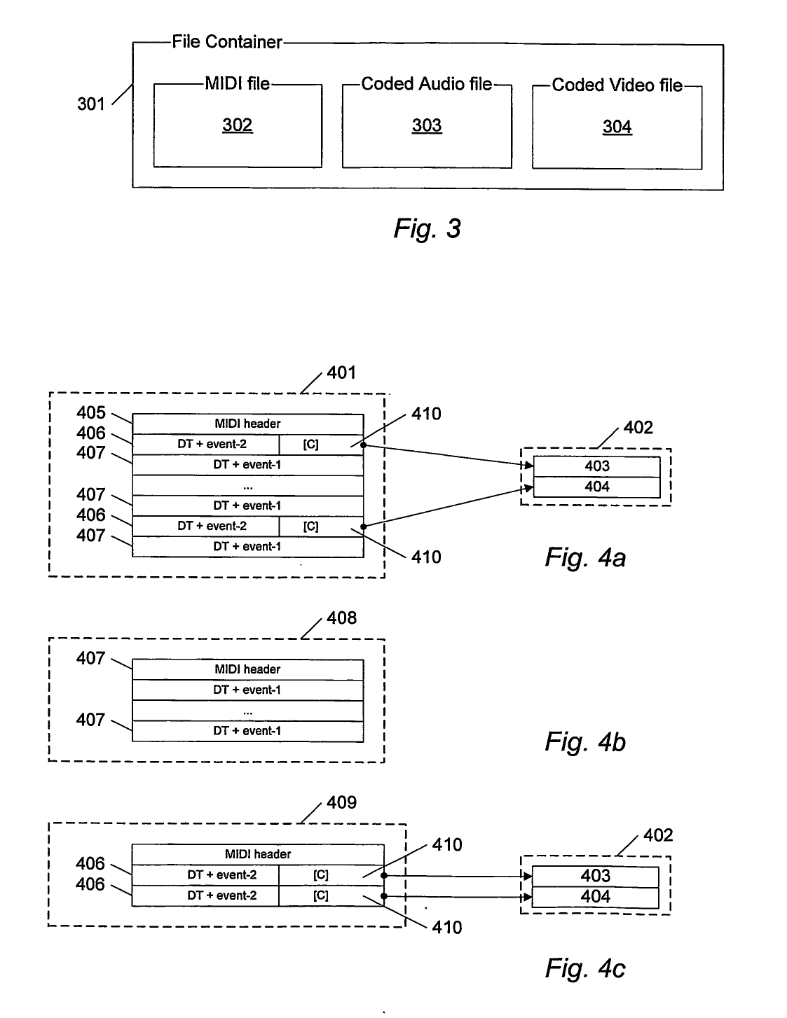

FIG. 3 illustrates a file container;

FIG. 4a illustrates the structure of an event-based multimedia signal combined with coded audio data and event-based references to the coded audio data;

FIG. 4b illustrates the structure of an event-based multimedia signal;

FIG. 4c illustrates the structure of coded audio data and event-based references to the coded audio data;

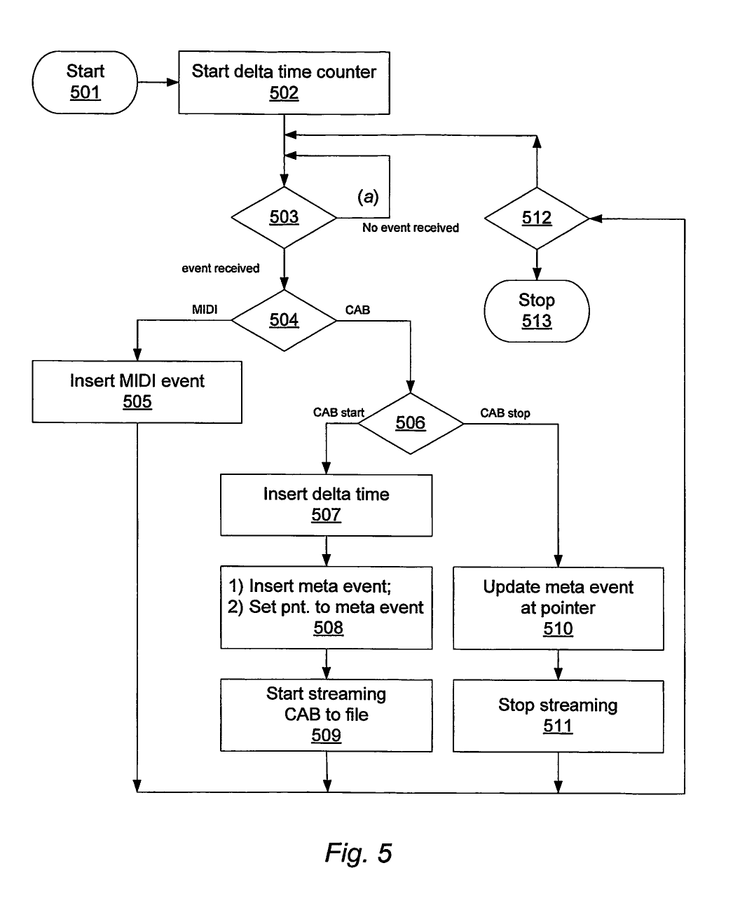

FIG. 5 shows a flowchart of a method of composing a multimedia signal;

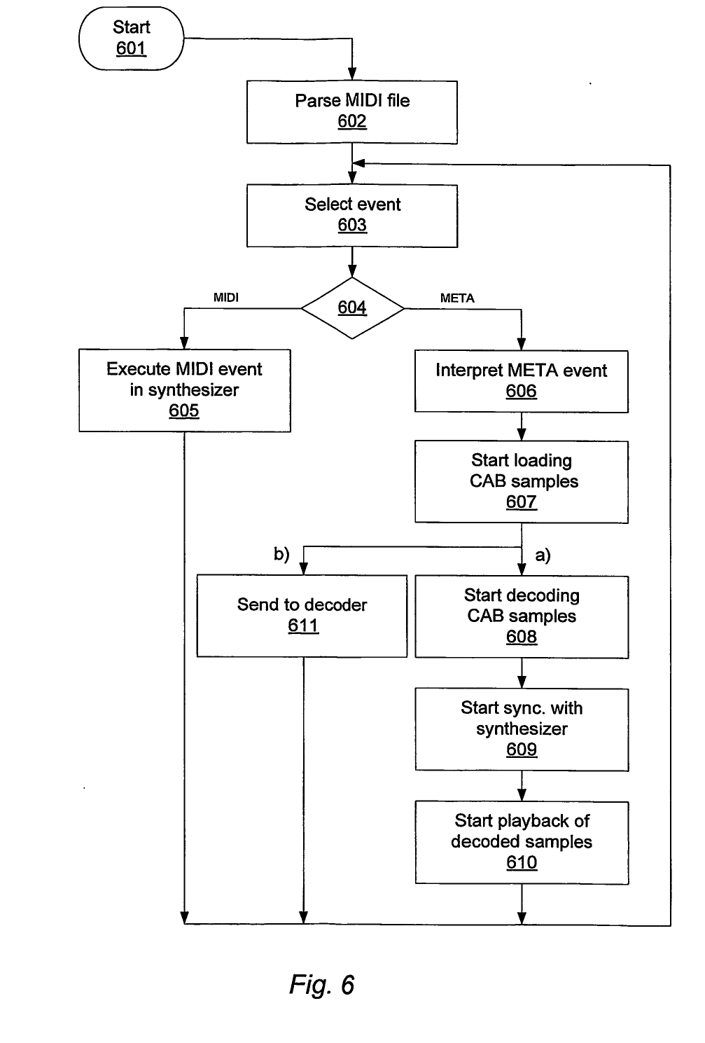

FIG. 6 shows a flowchart of a method of decomposing a multimedia signal;

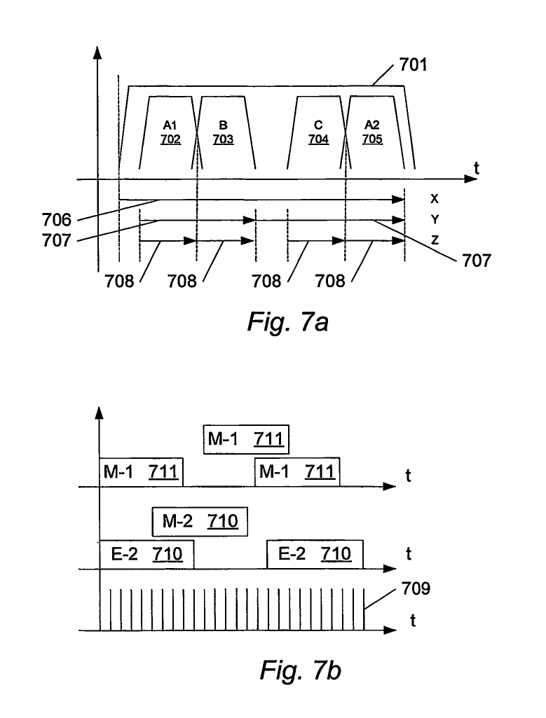

FIG. 7a illustrates a schematic envelope of a multimedia signal; and

FIG. 7b illustrates temporal aspects of MIDI events, coded audio events and samples of a playback signal.

FIG. 1 illustrates a unit for composing a multimedia signal. The unit 100 comprises two main signal paths; a first, via which MIDI messages from the OUT port of a MIDI generating device, eg a keyboard or another instrument, or a sequencer is provided; and a second, via which sampled audio is received, encoded, and stored, and wherein instructions to an audio or speech decoder are inserted. Here, the term sequencer is intended to comprise a computer program adapted to create MIDI compositions off-line as well as a hardware or software unit adapted to execute a MIDI file.

The first signal path of the unit 100 comprises a MIDI IN port 104 via which signals or files in accordance with the MIDI specification can be received. These signals are passed on to a merger 105 where the signals received on the port 104 are merged with signals provided via the second signal path. The signals provided via the first path comprise MIDI messages including MIDI events and optionally MIDI headers and other well-known MIDI information. It should be noted that another term for merger may be adder.

The second signal path of the unit 100 comprises a sampler 101 for sampling audio signals and/or video signals to provide sampled audio or video signals. Thus, these samples can represent a multimedia content which may comprise audio and/or video. Typically, audio signals are in the frequency range 20 Hz-20 KHz; audio signals conveying vocal song or vocals performance only are in the frequency range about 100 Hz-5 KHz. This allows for an encoding of the vocals alone with a considerably lower bit-rate than would be required for a melody including vocals. In an alternative embodiment, the sampler 101 is replaced by an input port arranged to receive sampled audio and/or sampled video, e.g. Pulse Code Modulated samples.

The sampled audio/video signals are sent to an encoder 102, by means of which the sampled audio/video signals are encoded to a compressed format. Thus, a first output from the encoder is a compressed format file or signal or more generally, data. This file or signal is stored in a sample bank 106, wherefrom the compressed format file or signal can be retrieved for subsequent decoding. A second output from the encoder comprises an address of the compressed format file or signal. The first output can be generated by means of well-known encoding schemes such as, for audio: MP3, which is the MPEG1 layer 3 (MPEG=Moving Picture Experts Group); AMR (Adaptive Multi Rate); and MC (Advanced Audio Codec), and for video: MPEG-4 video coding, which is a so-called block-based predictive differential video coding scheme. The address in the second output is generated by registering where the compressed format file or signal is stored.

Based on the stored compressed format file and the address thereof, an event inserter 103 is arranged to generate an event in accordance with the MIDI specification. The event can be of the System Exclusives (Sysex) type or Meta type as defined in the MIDI specification. The address is inserted after an indication of the type of event and after an indication of the number of bytes to follow.

According to the MIDI specification, the syntax for a system exclusives event is the following: F0 <length> <bytes to be transmitted after F0>. Here, F0 is an identifier identifying the type of the event being a Sysex event. The identifier is followed by a field <length> with a value indicating the length in bytes of the following bytes of the event. The field <bytes to be transmitted after F0> is also denoted additional content in the context of the present invention. In this latter field information for addressing the compressed format data and any other information is placed.

A very simplistic example of the use of System Exclusives could appear like the following fragment of an event according to the MIDI specification and in accordance with an aspect of the invention:

64

F0 09 7D 7F xx xx 00 00 00 B7

In the first line 64 HEX indicates that the following event is to be executed at a delta-time of 100 ticks with a specified ticks-duration. In the second line F0 indicates start of a system exclusives event. 09 HEX indicates the number of bytes succeeding the F0 code. At the following position, code 7D indicates that the event is for research use, and hence not occupied by a specific manufacturer of MIDI equipment. Thereby, the code 7D can be used in accordance with the present invention. At the following position, 7F indicates that all devices are used, however, a specific device can be used by writing a respective device ID of the device to use. At the next two positions, indicated by xx xx it is possible to state sub IDs for the device stated at the preceding position. Subsequently, the, 00 00, indicates a start frame and 00 B7 indicates a stop frame.

For META events of the cue-point type the syntax is the following: FF 07 <length> <text>. Here, FF 07 is an identifier identifying the type of the event. The identifier is followed by a field <length> with a value indicating the length in bytes of the following bytes of the event. The field <text> is also denoted additional content in the context of the present invention. In this latter field information for addressing the compressed format data and any other information is placed.

Thus, a corresponding example for a META event of the cue-point type could appear like the following fragment:

64

FF 07 05 00 00 00 B7

Again, the first line 64 HEX indicates that the following event is to be executed at a delta-time of 100 ticks. In the second line FF 07 indicates start of a META event of the cue-point type. 05 indicates the length of the event with the additional content 00 00 00 B7, wherein 00 00, indicates a start frame and 00 B7 indicates a stop frame. In decimal representation the above line starting with HEX FF is:

255 7 5 0 0 0 183

This representation may be preferred instead of the HEX representation.

Turning back to the unit 100, the function of the adder 105 is to merge the signals comprising events provided from the first and the second signal path. This is carried out by merging the signals such that the output from the adder comprises events each preceded by delta-time stamps, which occur in either ascending or descending order.

FIG. 2 illustrates a unit for decomposing a multimedia signal. The unit 200 comprises a parser 201 that is arranged to split a signal in accordance with the MIDI specification into two signals. In a first embodiment, the parser is based on identifying events of a second type which are identifiable separately from events of a first type. The events of the second type can be events identified by a given value or bit-pattern. Thus events of the first type can be identified as events not being of the second type. Any delta-time stamps preceding an event are split to follow the succeeding event. Events of the first type are then output on a port A and events of the second type are output on port B.

In a second, altemabve, embodiment, the parser is arranged to pass on all events to port A, while making a copy of events and their preceding delta-time which are determined to be of the second type.

In a third, alternative, embodiment, the parser is arranged to remove a portion of the additional content that fulfils a given criterion before sending the otherwise intact signal to port A. The portion of the additional content that fulfils a given criterion is forwarded to port B with the events of the second type that comprises the identified additional content and any preceding delta-time value.

Output on port A of the parser 201 is sent to a synthesizer 202, wherein the received MIDI signal is interpreted to make an analogue or digital reproduction of the musical composition described by the MIDI signal.

Output on port B of the parser 201 is sent to an interpreter 203, wherein additional content is interpreted together with a delta-time value preceding the event that was conveying the additional content. This interpretation comprises a determination of the address at which to retrieve the compressed format file that it is intended to play at the time instance set by the delta-time value. Optionally, the interpreter can identify the type of coding scheme used to encode the compressed format file by reading information indicative thereof, if present. Based on the determined address the thereby referenced portion of the compressed format file is retrieved from the sample bank 106 via the interface 204. The retrieved portion is sent to a decoder 205, wherein the coded samples are decoded to provide a signal that can be mixed with the analogue or digital reproduction provided from the synthesizer 202. The signals are mixed by means of adder 208 providing a mixed signal for playback by means of an amplifier 207 and a loudspeaker 209. In order to achieve synchronisation between the two signals provided to the adder 208 synchronization block 210 is provided. This synchronization block can be implemented by controlling the operation of the synthesizer 202 relative the decoder 205 or vice versa. However, the synchronization can be implemented in other ways.

In one embodiment, the interpreter 203 translates the delta-time of each meta event that identifies a coded sample to a presentation time for the corresponding sample, wherein the presentation time is a point in time as determined by the system time of the processing unit. When the interpreter dispatches a command to the interface 204 for retrieval of the coded sample and for decoding of the retrieved sample by the decoder 205, the interpreter includes a presentation time stamp in the command which indicates at what point in system time the corresponding sample should be played. The coded sample is then queued in a queue of the decoder 205 for processing at the corresponding system time.

It should be noted that the term ‘referenced portion of the compressed format file’ also can be denoted a Compressed Audio Block, CAB; Compressed Video Block, CVB; or Compressed Multimedia Block CMB.

FIG. 3 illustrates a file container. The file container 301 comprises a MIDI file 302 and a coded audio file 303. Optionally, or alternatively, the file container can comprise a coded video file 304. The coded audio file 303 and/or the coded video file 304 is referred to, in the above, as the sample bank 106. By means of the file container 301, a complete musical composition with an instrumental portion and a vocal song or vocals portion can be distributed as a single file. The coded audio file 303 can comprise multiple Compressed Audio Blocks. It should be clear that the components in the container may be interleaved to facilitate a suitable format for streaming.

FIG. 4a illustrates the structure of an event-based multimedia signal combined with data in compressed audio blocks, compressed video blocks or compressed multimedia blocks and event-based references to the blocks. The event-based multimedia signal 401 comprises events of the above mentioned first type 407 (event-1) and the second type 407 (event-2). The structure 401 illustrates the structure of a signal provided by the adder 105, and a signal received by the parser 201. In the second, altemative, embodiment of the parser 201 the structure also represents the signal as provided on port A of the parser.

The coded audio data 402 comprises blocks 403 and 404 of coded audio. These blocks are addressed by event-based references 410 which are embedded in the content of an event 406 of the second type. The delta-time stamp DT preceding an event, determines the point in time at which to start playback of a respective block of coded audio.

FIG. 4b illustrates the structure of an event-based multimedia signal. The structure 408 illustrates a MIDI signal wherein events 407 of the first type only are present. Hence, there are no references to coded audio or video.

FIG. 4c illustrates the structure of coded audio data and event-based references to the coded audio data. The structure 409 comprises events 406 of the second type each with a reference to coded audio or video.

FIG. 5 shows a flowchart of a method of composing a multimedia signal. The methods starts in step 501 and proceeds to step 502 wherein a counter counting units of time is started; the counter is denoted a delta-time counter. Subsequently, in step 503 it is examined whether a received event is either a MIDI signal or an audio/video signal. If no events are detected, the method will continue examining whether an event is received until an event is received. In the latter-mentioned case, the method will proceed to step 504, wherein it is examined whether the detected event is either an event that represents arrival of a MIDI event or an event (CAB) representing start or stop of the transmission of a coded audio block.

In case a MIDI event arrives, a delta time for the MIDI event is inserted. Subsequently, the MIDI event is inserted in step 505 into the multimedia signal which is being composed.

In case a block of audio/video starts being received or terminates being received, it is determined whether the block starts or stops. In case the block starts being received, a delta-time stamp is generated in step 507 based on the count of the delta-time counter. In step 508, a meta-event is generated. Since the complete address of the block of audio/video may not be known a pointer is set to the generated meta-event. Subsequently, streaming of the coded audio block to file storage is started. The file storage may be an audio file in a file container.

In case a block of audio/video terminates being received, the meta-event referenced by a pointer set in step 508 is updated with any remaining address information to provide complete information for accessing the stored data. Subsequently, the process of streaming the coded audio block to the file is terminated in step 511.

When the steps 508 or 509 or 511 have been completed, the method resumes at step 503 to examine whether any events are being received. However, as an option it can be examined in step 512 whether to stop the method. However, it should be avoided stopping the method during the process of streaming data to the coded audio data.

FIG. 6 shows a flowchart of a method of decomposing a multimedia signal. The method starts in step 601, wherefrom the method proceeds to step 602 to parse a received MIDI file or signal. In subsequent step 603 events of the MIDI file or signal are selected one-by-one and their type is determined. The events can be MIDI events conveying instrumental musical performance or META events conveying information as set out in the MIDI specification and/or information for locating coded audio data. In step 604 MIDI events are passed on to step 605 and META events are passed on to step 606.

In step 605 MIDI events are executed in a synthesizer to provide a reproduction of the instrumental portion of a composition or alternatively, transmitted to a synthesizer.

In step 606 events determined to be of the META event type with any additional content are interpreted to deduce eg an address and/or a filename at which coded audio data are located. In step 607, loading of coded audio samples is started and continues while in a range specified by the address. After step 607 a route ‘a)’ indicates a first embodiment while route ‘b)’ indicates a second embodiment. According to the a) route, decoding of coded audio samples is started in step 608. In order to ensure synchronisation between sound produced by the synthesizer 605 and the coded audio, synchronisation is started in step 609 before and maintained during playback of the decoded samples in step 610. According to the b) route, the addressed, coded audio samples are sent to a decoder in step 611 for subsequent playback.

As described in connection with FIG. 2 above, the synchronisation of the playback of the coded samples relative to the playback of the MIDI components may be performed by translating the delta-times into a presentation time stamp for each identified coded sample, where the presentation time stamp determines a point in system time at which the sample is to be played back. The time-stamped sample is then forwarded to the decoder.

FIG. 7a illustrates schematic envelopes of a multimedia signal. The envelopes are depicted as a function of time t. The envelope 701 represents musical composition with duration of typically 2.5 to 10 minutes. The musical composition comprises, for illustrative purpose, four portions A1, B, C, and A2 of vocal song or vocals.

In a first embodiment, the vocal song or vocals portions can be encoded in a single and continuous block of data as illustrated by the arrow 706.

In a second embodiment, the vocal song or vocals portions can be encoded in several blocks of data, as illustrated by arrows 707. The blocks can be arranged temporally to cover only the parts where vocal song or vocals is appreciated. Each block is represented in MIDI by means of a delta-time stamp and a meta-event with additional content for addressing the block in storage memory.

In a third embodiment, the blocks can be arranged temporally to cover vocal song or vocals fractions corresponding to fractions of the lyric that are sung. Thereby, coded samples of a fraction of a vocal song or vocals are contained in a block. If fractions of a vocal song or vocals are repeated for instance three times, these three fractions can be reproduced by playback of the same fraction. Additionally, since the duration of pauses between spoken words may amount to a considerable fraction of a speech or song, playback using multiple reproductions of even single words can be efficient. Thereby, further achievements in compression of a multimedia signal are obtained.

FIG. 7b illustrates temporal aspects of MIDI events, coded audio events and samples of a playback signal. It is illustrated that samples are reproduced periodically at even points in time e.g. at a sample rate of 44.1 or 48 KHz. At a less frequent rate MIDI events 711 i.e. events of the first type, occur in a MIDI file with information on which of patches to use for playback, which of notes to play, and at which of sound levels to play each of the notes. The playback of the individual notes is defined in the events and can result in simultaneous playback of different notes, overlapping playback etc. This depends on the information in the events and can include attack, decay, sustain, and fade durations.

For events with information according to the invention and at a rate determined by the size of the coded audio blocks as discussed above, META events 710, i.e. events of the second type, occur. These events determine the playback of the vocal song or vocals performance and may result in simultaneous or overlapping playback of coded audio blocks—or in consecutive playback as illustrated in FIG. 7a.

Generally, track chunks include different types of events: A first type of events are the so-called MIDI events, and a second type of events include the so-called Meta-events and Sysex-events that carry the additional content. Each chunk is simply a stream of events, in the following also referred to as “M events”, preceded by delta-time values. The syntax is the following:
<track chunk>=<length><M event>+

Wherein the plus sign ‘+’ indicates that several of the fields <M event> typically will occur.

The syntax of an M event is very simple:
<M event>=<delta time><event>

Here, <delta-time> is stored as a variable length quantity. It represents the amount of time before the following event. If the first event in a track occurs at the very beginning of a track, or if two events occur simultaneously, a delta-time of zero is used. Delta times are always present in standard MIDI file. Delta-time is in ticks as specified by the header chunk.
<event>=<MIDI event>|<sysex event>|<meta-event>

Here, it is indicated that the field <event> can be any one of the types <MIDI event> or <sysex event> or <meta-event>.

The field <MIDI event> contains any MIDI channel message.

The field <sysex event> is used to specify a MIDI system exclusive message, either as one unit or in packets, or as an ‘escape’ to specify any arbitrary bytes to be transmitted. According to the invention, Sysex events can convey information in the form of direct or indirect addresses or instructions to control playback of coded audio or video. It should be noted that the so-called multi-packet aspect of the sysex event is applicable within the scope of the invention.

The field <meta-event> comprises meta-events of the type ‘Cue points’ with the syntax FF 07 <length> <text>, wherein the field <text> can convey the additional information according to the invention. Specific types of cue points can refer to individual event occurrences; each cue number may be assigned to a specific reaction, such as a specific one-shot sound event. The specific one-shot event can be to decode a specific CAB, CVB, or CMB. In this case, the specific block can be associated with a specified event number.

Additionally the field <meta-event> comprises meta-events of the type ‘Lyric’ with the syntax FF 05 <length> <text> and ‘text event with the syntax FF 01 <length> <text> wherein the fields <text> can convey the additional information according to the invention.

Generally, it should be noted that the invention is not limited to the Musical Instrument Digital Interface (MIDI). Advantages of the present invention can be obtained for all types of files or streams of data where events carry at least a partial representation of content in a composition e.g. in the form of a multimedia signal—especially an audio signal. Here, events are associated with information of at which temporal instance to reproduce a specified vocal and/or musical and/or video and/or other multimedia performance. Preferably, however, the invention is especially advantageous with any protocol that operates relative to a type of time line and a type of meta events. In fact, a 3GP container used in 3GPP can be attached with text files along the time line, where the text file carries information for reproducing a multimedia performance and/or addresses/pointers to such information.

Additionally, it should be noted that the invention i.e. is explained in connection with MIDI and musical and/or vocal performance. The term ‘multimedia’ and/or ‘multimedia signal’ and/or ‘multimedia performance’ comprises ‘audio’ and/or ‘audio/signal’ and/or ‘audio performance’, respectively, where audio comprises music and/or vocals. It will be appreciated that the invention may also be applied to multimedia file/data formats, such as files according to the “extensible music format” (XMF), MOD files, or the like.

Furthermore, it should be noted that the meta control of audio, song or vocals according to the present invention allows to point to any file at any location within the file. Thereby, an efficient and flexible representation of a musical composition in combination with song, speech, vocals, or other audio content is provided.

The method, product means, and device described herein can be implemented by means of hardware comprising several distinct elements, and by means of a suitably programmed microprocessor. In particular, the features of the method described herein may be implemented in software and carried out on a data processing device or other processing means caused by the execution of program code means such as computer-executable instructions.

In some instances, the program may be supplied to the user encoded on a CD-ROM or a floppy disk (both generally depicted by the storage device), or alternatively could be read by the via a computer network. Still further, the computer system can load the software from other computer readable media. This may include magnetic tape, a ROM or integrated circuit, a magneto-optical disk, a radio or infra-red transmission channel between the computer and another device, a computer readable card such as a PCMCIA card, and the Internet and Intranets including email transmissions and information recorded on Internet sites and the like. The foregoing are merely examples of relevant computer readable media. Other computer readable media may be practiced without departing from the scope and spirit of the invention.

In the device claims enumerating several means, several of these means can be embodied by one and the same item of hardware, e.g. a suitably programmed microprocessor, one or more digital signal processor, or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A method of rendering a multimedia signal, the multimedia signal comprising events of a first type arranged to carry content in the form of instructions to a rendering unit and an event of a second type arranged to carry additional content, wherein said additional content comprises an address identifying an encoded sample of multimedia content, wherein the method comprises the following steps:
generating a multimedia output in response to the events of the first type;
parsing the multimedia signal to identify said event of the second type and to read the additional content;
loading the encoded sample of multimedia content identified by said address;
decoding the encoded sample to provide a decoded sample for playback of the multimedia content; and
superimposing the decoded sample on the generated multimedia output in accordance with timing information associated with the event of the second type.

2. The method according to claim 1, wherein the timing information comprises a delta time value defining a time relative to a reference time.

3. The method according to claim 1, wherein the event of the second type includes a textual information of one or more predetermined commands, the one or more commands identifying an encoded sample.

4. The method according to claim 1, wherein the step of superimposing includes synchronizing the decoded sample with the multimedia output based on the timing information.

5. The method according to claim 1, wherein the multimedia signal and the encoded sample are included in a container data item.

6. The method according to claim 1, wherein the event of the second type comprises a System Exclusives event as defined in the specification of the Musical Instrument Digital Interface (MIDI).

7. The method according to claim 1, wherein the event of the second type comprises a Meta-event as defined in the specification of the Musical Instrument Digital Interface (MIDI).

8. The method according to claim 7, wherein the event of the second type comprises a Meta-event of the type cue-points, identified by the hexadecimal value FF 07.

9. The method according to claim 7, wherein the event of the second type comprises a Meta-event of the type Iyric. identified by the hexadecimal value FF 05.

10. The method according to claim 7, wherein the event of the second type comprises a Meta-event of the type text, identified by the hexadecimal value FF 01.

11. The method according to claim 1, wherein the address indicates a position in a first file associated with the multimedia signal.

12. The method according to claim 11, wherein the multimedia signal is stored in a second file.

13. The method according to claim 1, wherein the additional content comprises an indication of a type of coding scheme used for encoding the encoded samples.

14. The method according to claim 1, wherein the multimedia signal complies with the general Musical Instrument Digital Interface (MIDI) specification.

15. A unit for rendering a multimedia signal, the multimedia signal comprising events of a first type which are arranged to carry content in the form of instructions to the unit, and an event of a second type arranged to carry additional content, wherein said additional content comprises an address identifying an encoded sample of multimedia content, wherein the unit comprises:
a playback unit adapted to generate a multimedia output in response to the events of the first type;
a parser arranged to identify the event of the second type and to read the additional content;
an interface arranged to load the encoded sample of multimedia content identified by said address, and to cause a decoder to decode the decoded sample for subsequent playback of the multimedia content; and
a synchronizing unit adapted to synchronize playback of the decoded sample with the generation of the multimedia output.

16. The unit according to claim 15, wherein the multimedia signal complies with the general Musical Instrument Digital Interface (MIDI) specification.

17. The unit according to claim 15, wherein the timing information comprises a delta time value defining a time relative to a reference time.

18. The unit according to claim 15, wherein the event of the second type includes a textual information of one or more predetermined commands, the one or more commands identifying an encoded sample.

19. The unit according to claim 15, wherein the multimedia signal and the encoded sample are comprised in a container data item.

20. The unit according to claim 15, wherein the event of the second type comprises a System Exclusives event as defined in the specification of the Musical Instrument Digital Interface (MIDI).

21. The unit according to claim 15, wherein the event of the second type comprises a Meta-event as defined in the specification of the Musical Instrument Digital Interface (MIDI).

22. The unit according to claim 21, wherein the event of the second type comprises a Meta-event of the type cue-points. identified by the hexadecimal value FF 07.

23. The unit according to claim 21, wherein the event of the second type comprises a Meta-event of the type lyric, identified by the hexadecimal value FF 05.

24. The unit according to claim 21, wherein the event of the second type comprises a Meta-event of the type text, identified by the hexadecimal value FF 01.

25. The unit according to claim 15, wherein an address indicates a position in a first file associated with the multimedia signal.

26. The unit according to claim 25 wherein the multimedia signal is stored in a second file.

27. The unit according to claim 15, wherein the additional content comprises an indication of a type of coding scheme used for encoding the encoded samples.

28. A computer program product comprising program code means executed on a data processing device, said computer program product rendering a multimedia signal, the multimedia signal comprising events of a first type arranged to carry content in the form of instructions to a rendering unit and an event of a second type arranged to carry additional content, wherein said additional content comprises an address identifying an encoded sample of multimedia content, wherein the program code means is adapted to:
generate a multimedia output in response to the events of the first type;
parse the multimedia signal to identify the event of the second type and to read the additional content;
load the encoded sample of multimedia content identified by the address;
decode the encoded sample to provide a decoded sample for Playback of the multimedia content; and
superimpose the decoded sample on the generated multimedia output in accordance with timing information associated with the event of the second type.
